(19) United States
(12) Patent Application Publication
(10) Pub. No.: US 2010/0214095 A1
(43) Pub. Date: Aug. 26, 2010

(54) LOCATOR SYSTEM WITH AUDIBLE LOCATION INDICATOR

(76) Inventor: Vicki C. Davide, Massillon, OH (US)

Correspondence Address: SAND & SEBOLT, AEGIS TOWER, SUITE 1100, 4940 MUNSON STREET, NW, CANTON, OH, 44718-3615, US

(21) Appl. No.: 12/389,914

(22) Filed: Feb. 20, 2009

(51) Int. Cl. G08B 1/08

(52) U.S. Cl. 340/539.32

(57) ABSTRACT

A system for locating a misplaced article comprising a transmitter capable of generating and transmitting a first signal, a receiver/transmitter capable of receiving the first signal and transmitting a second signal, and a location indicator capable only of receiving the second signal and generating a response thereto. The response is detectable by a person and preferably is an audible sound. The location indicator is free of components that would permit it to generate and transmit an electronic signal to another electronic device. The location indicator is pre-engaged with the article before it is misplaced.

### BACKGROUND OF THE INVENTION

1. Technical Field

This invention generally relates to locator systems. More particularly, the invention relates to a locator system that includes an active transmitter and a passive receiver. Specifically, the invention relates to a locator system that includes a phone that, when activated, transmits a signal via a cell phone network to a receiver. The receiver emits an audible sound when it receives the signal and thereby indicates the receiver's location.

2. Background Information

One of the most frustrating things that can occur to a person is to need an article such as a set of car keys or a remote control for a television set, and be totally unable to find that article.

It is an object of the present invention to provide a system that will aid a person in quickly and easily locating a misplaced article.

### SUMMARY OF THE INVENTION

A system in accordance with the present invention is useful for locating a misplaced article. The system comprises a transmitter capable of generating and transmitting a first signal, a receiver/transmitter capable of receiving the first signal and either relaying the first signal or transmitting a second signal, and a location indicator capable only of receiving the second signal and generating a response thereto. The location indicator is designed to be pre-attached to the article prior to it being misplaced. The response generated by the location indicator is designed to be easily detected by a person. Preferably, the response is an audible sound.

The transmitter preferably is a phone and the receiver/transmitter preferably is a phone network, a remote cellular phone tower or satellite. The location indicator is a passive receiver that is free of components such as a keypad, a touchpad, a touchscreen, or a voice-activation system that is used to initiate, generate and transmit an electronic signal to another electronic device.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a front elevational view of the locator system in accordance with the present invention;

FIG. 2 is a front view of the passive receiver of the locator system and the object to which that locator system is to be attached; and

FIG. 3 is a front view of the receiver of the locator system that has been opened to reveal the components within the housing of the receiver.

### DETAILED DESCRIPTION OF THE INVENTION

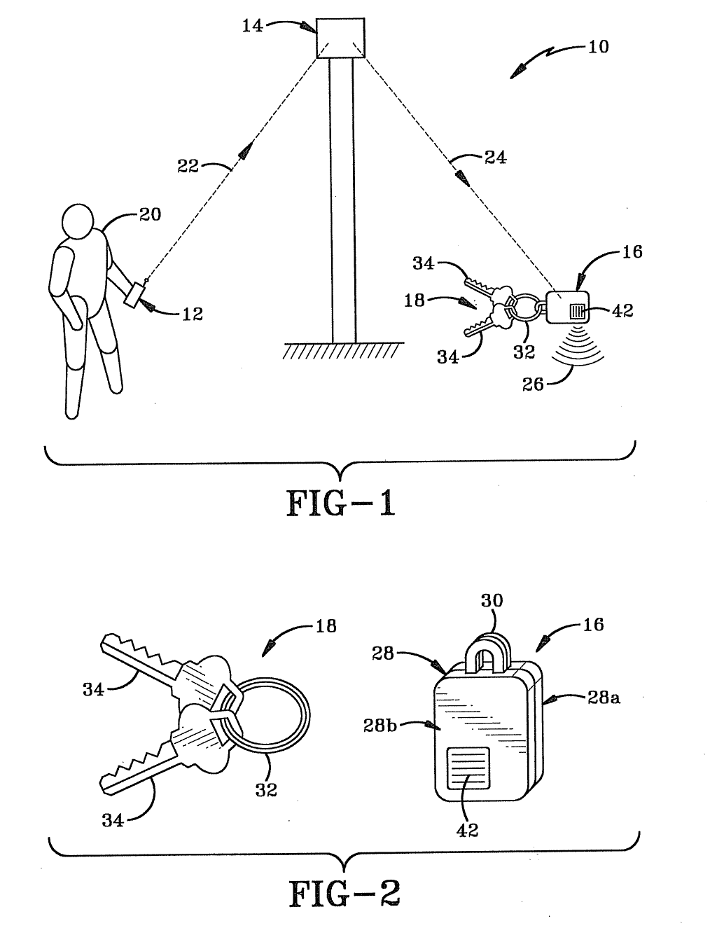

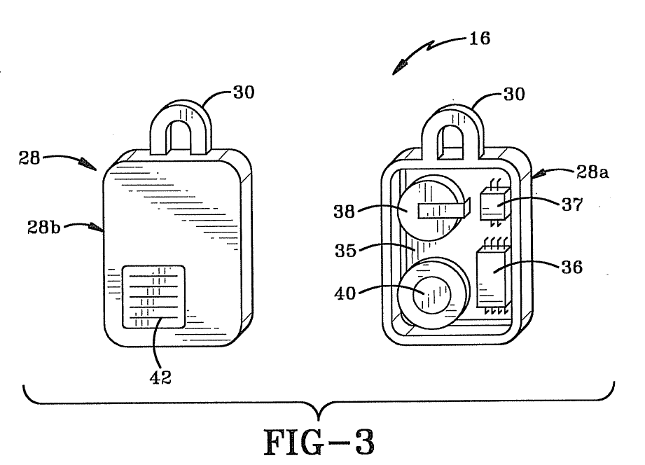

Referring to FIGS. 1-3, there is shown a locator system in accordance with the present invention and generally indicated at 10. Locator system 10 includes a transmitter 12, a receiver/transmitter 14 and a location indicator 16. Preferably, transmitter 12 is an electronic device such as a cellular phone, smart phone, a land-line telephone, or a computer. It will be understood, however, that any device capable of generating and transmitting an electronic signal is contemplated to fall within the scope of this invention. Specifically, any device capable of generating and transmitting an electromagnetic signal is contemplated to fall within the scope of the invention. The signal may be of an analog or a digital nature. The receiver/transmitter 14 preferably is a cellular phone tower, a satellite, a phone network, a computer or computer server, or other intermediary electronic device that is able to both receive an electronic signal and transmit an electronic signal. Specifically, the receiver/transmitter 14 is contemplated as a device that is capable of receiving an electromagnetic signal and then relaying that first signal or generating and transmitting a second electromagnetic signal. Neither of the first and second signals from the transmitter 12 and receiver/transmitter 14 is contemplated to be of a type that would be able to be seen or heard by a person.

The location indicator 16 is designed to be secured beforehand to an article 18. This article 18 may be any article that the person anticipates they might later inadvertently misplace and therefore need to find, such as a set of keys or a remote control for a television. The location indicator 16 is contemplated to be any device that is capable of receiving a signal and then generating an audible or visual response for a person to detect. The location indicator 16, however, preferably is contemplated to only be a passive device that is not or cannot be used to initiate, generate and/or transmit an electronic signal to another electronic device.

Transmitter 12 permits a person 20 to generate and transmit a first signal 22 to the receiver/transmitter 14. Receiver/transmitter 14, in turn, transmits a second signal 24 which is received by the location indicator 16. In response to the receipt of the second signal 24, location indicator 16 emits a sound 26. The sound 26 is audible and can be used by a person 20 to find the location indicator 16. Since the location indicator 16 is attached to article 18, when the person 20 locates the location indicator 16, they automatically find the misplaced article 18.

In accordance with a specific feature of the present invention, location indicator 16 preferably comprises a housing 28 made up of a first part 28a and a second part 28b. The first and second parts 28a, 28b preferably are molded from a suitable plastic and are designed to snap fit together or be secured together by an adhesive or one or more fasteners. Location indicator 16 preferably is similar in configuration and components to a cellular phone except that it does not include a keyboard, a touchpad, touchscreen, voice-activation system, or any other component that would permit indicator 16 to initiate or generate an electronic signal therefrom and then transmit that generated signal to a receiver on another electronic device. For instance, location indicator 16 therefore preferably is not a device such as a second cellular phone that could transmit an electronic signal to a remote cellular phone tower.

Location indicator 16 preferably further includes a suitable means for attaching the housing 28 to article 18. By way of example only, FIGS. 1&2 show the article 18, comprising a plurality of keys 34 that are attached to a key ring 32. In this instance, each of first and second parts 28a, 28b of housing 28 is provided with an apertured flange 30 that projects outwardly from a surface of the housing. Key ring 32 is received through the aperture in flange 30 thereby securing key ring 32 and housing 28 together. If the person misplaces their keys, the location indicator 16 is misplaced with them.

Although not illustrated herein, it will be understood that location indicator 16 does not have to be provided in a configuration that permits it to be externally attached to an article 100. The indicator 16 may, alternatively, be disposed within the interior of a housing of an article that may at some later time become misplaced. In yet another format, indicator 16 may be incorporated into a device, such as a television remote control device, during manufacture of the same. So, for example, in the case of a TV remote control, the housing of the remote control may be provided with a receiver, a speaker grille and a speaker, separate microprocessor and activation buttons all retained within the housing. These components in the remote control will permit the device to act as a passive receiver that will generate an audible response upon receipt of an electronic signal. The signal may be sent from an appropriate receiver/transmitter, such as a satellite or a computer server. The remote control would also contain a separate microprocessor, activation buttons etc. for generating and transmitting a response to a remote electronic device, such as a TV or DVD player. This second microprocessing system could not be used to locate a misplaced remote control and would only be useful for the functions normally associated with a remote control such as changing the channel, increasing or decreasing the volume, etc. In accordance with a specific feature of the present invention, location indicator 16 includes a circuit board 35, a microprocessor 36, a receiver 37, a power source 38 and a speaker 40 that are in electronic communication with each other. All of these components are illustrated as retained with first part 28a of housing 28. Second part 28b of housing 28 is secured thereover and includes a speaker grille 42 through which a sound, generated by speaker 40, may be heard. Although not illustrated herein, housing 28 may further include a light-emitting component to visually signal the position of location indicator 16 to a person.

Microprocessor 36 preferably is of a type that is typically used in a cellular phone. Speaker 40 preferably is also of a type that would typically be found in a cellular phone although it does not need to be that sophisticated. The housing 28 and the components retained therein are therefore similar to a cellular phone with the exception that the device lacks any component that will enable it to generate and transmit an electronic signal to another electronic device. Location indicator 16 therefore does not have a keyboard, a touchpad, a touchscreen, or a voice-activation system, and does not include any type of electronic transmitter disposed therein. In other words, location indicator 16 is simply a passive receiver that is capable of emitting sound in response to a received signal. The microprocessor 36 is programmed to receive a second signal 24 that is transmitted or relayed from receiver/transmitter 14 and then to cause a sound 26 to be emitted from speaker 40.

The device of the present invention is used in the following manner. The person 20 attaches the location indicator 16 to the article 18 which they are concerned they may misplace at a future time. Location indicator 16 has been preprogrammed to receive calls to a preauthorized phone number. When it later turns out that article 18 has been misplaced, the person dials or otherwise enters the preauthorized phone number into transmitter 12. Transmitter 12 generates a first signal 22 which is received by receiver/transmitter 14. Receiver/transmitter 14 generates and transmits a second signal 24 to the preauthorized phone number in response. Alternatively, receiver/transmitter 14 simply relays first signal 22, but this is not illustrated in the attached drawings. Location indicator 16, which has been preprogrammed to receive signals to the preauthorized phone number, receives the signal 24. In response to this signal 24, location indicator 16 generates the audible sound 26. The sound 26 is emitted either as a single, continuous sound, as an intermittent sound or as a single sound of limited duration. The person simply listens for the sound generated by location indicator 16 to aid them in locating the indicator device 16 and, therefore, the misplaced article 18 which is attached thereto. If location indicator 16 only emits a single short burst of sound, the person 20 may have to redial the preauthorized phone number several times in order to find location indicator 16. If the location indicator 16 is designed to emit a single, long, continuous sound, then location indicator 16 will likely include a deactivation button (not shown) that would enable the person 20 to deactivate the speaker 40 once article 18 has been found.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A system for locating a misplaced article, said system comprising:
a transmitter capable of generating and transmitting a first signal;
a receiver/transmitter capable of receiving the first signal and transmitting a second signal; and
a location indicator adapted to be engaged with the article prior to it being misplaced, said location indicator being capable only of receiving the second signal and generating a response thereto that is easily detected by a person.

2. The system as defined in claim 1, wherein the response is an audible sound.

3. The system as defined in claim 1, wherein the location indicator is free of any components capable of initiating, generating and transmitting an electronic signal to a receiver of another electronic device.

4. The system as defined in claim 3, wherein the location indicator is free of one or more of a keypad, a touchpad, a touchscreen and a voice activation system.

5. The system as defined in claim 1, wherein the transmitter is one of a cellular phone, a smart phone, a land-line telephone and a computer.

6. The system as defined in claim 5, wherein the transmitter/receiver is one of a cellular phone tower, a satellite, a phone network, a computer and a computer server.

7. The system as defined in claim 6, wherein the transmitter/receiver relays the first signal as the second signal.

8. The system as defined in claim 6, wherein the location indicator includes a microprocessor that is preprogrammed only to receive the second signal transmitted to a preauthorized phone number.

9. The system as defined in claim 1, wherein the location indicator includes a microprocessor that is in operational communication with a speaker.

10. The system as defined in claim 1, wherein the location indicator includes a power supply.

11. The system as defined in claim 1, wherein the location indicator includes:
a printed circuit board;
a microprocessor operationally connected to said circuit board;
a power source operationally connected to the microprocessor; and
a speaker operationally connected to the microprocessor.

12. The system as defined in claim 11, wherein the location indicator further includes a housing having a first section and a second section that are snap-fitted together; and wherein the first section of the housing includes a speaker grille; and the second section of the housing retains therein the circuit board, the microprocessor, the power source and the speaker, and wherein the speaker is disposed within the second section of the housing so that it is able to emit sounds through the speaker grille in the first section of the housing.

13. The system as defined in claim 12, wherein each of the first and second sections of the housing include a flange that projects outwardly away from an exterior surface thereof; and each flange defines an aperture therein, and wherein the flanges and apertures are aligned with each other and are adapted to be used to removably secure the housing to the article.

14. The system as defined in claim 11, wherein the circuit board, the microprocessor, the power source and the speaker are all adapted to be retained within a chamber in the article itself.

15. In combination;
an article that a person wishes to be able to locate if it becomes misplaced;
a transmitter capable of generating and transmitting a first signal;
a receiver/transmitter capable of receiving the first signal and transmitting a second signal; and
a location indicator engageable with the article prior to it being misplaced, said location indicator being capable only of receiving the second signal and generating a response thereto; where the response is detectable by a person.

16. The combination as defined in claim 15, wherein the location indicator comprises:
a housing having a first section and a second section that are snap-fitted together;
a printed circuit board retained within the housing;
a microprocessor retained within the housing and being in operational connection with said circuit board;
a power source retained within the housing and being in operational connection with the microprocessor; and
a speaker retained within the housing and being in operational connection with the microprocessor; and wherein said speaker is adapted to emit a sound through a grille in an exterior wall of one of the first and second sections.

17. The combination as defined in claim 16, wherein the housing further includes a flange projecting outwardly from one or both of the first and second sections thereof; and wherein the flange defines an aperture therethrough and the flange and aperture are adapted to be engaged with the article to secure the housing to the article

18. The combination as defined in claim 16, wherein the location indicator comprises:
a printed circuit board;
a microprocessor in operational connection with said circuit board;
a power source in operational connection with the microprocessor; and
a speaker in operational connection with the microprocessor; and wherein said speaker is adapted to emit an audible sound.

19. The combination as defined in claim 18, wherein the location indicator is retained within the article itself.
